(19) United States
(12) Patent Application Publication
(10) Pub. No.: US 2019/0235738 A1
(43) Pub. Date: Aug. 1, 2019

(54) METHOD FOR LOADING LARGE SIZE PHOTOGRAPH AND SYSTEM

(71) Applicant: JRD Communication (Shenzen) LTD., Shenzhen City (CN)

(72) Inventors: Bin YU, Shenzhen City (CN); Weiqin YANG, Shenzhen City (CN)

(73) Assignee: JRD Communication (Shenzen) LTD., Shenzhen City (CN)

(21) Appl. No.: 16/341,062

(22) PCT Filed: Sep. 5, 2017
(86) PCT No.: PCT/CN2017/100488

§ 371 Date: Apr. 11, 2019

(30) Foreign Application Priority Data
Oct. 12, 2016 (CN) 201610889427.0

(51) Int. Cl. G06F 3/0484; G06F 16/54; G06F 3/0488

(52) U.S. Cl. CPC G06F 3/04845; G06F 3/04883; G06F 16/54

(57) ABSTRACT

A method for loading large size photograph and a system are provided. The method comprises splitting a large size photograph into multiple sub-pictures having a preset size when a mobile terminal loads the large size photograph; and moving a next sub-picture to a position of a current sub-picture according to a user slide direction on a touch screen of the mobile terminal and displaying in real-time.

### BACKGROUND OF THE DISCLOSURE

### Field of Disclosure

The present disclosure relates to a field of mobile terminals, and in particular to method for loading large size photograph and a system.

### Description of Prior Art

In order to meet needs of users, photographs, taken by mobile terminals, have more and more pixels that an original size (photographing size) of the photograph taken on the mobile terminal increases. When the user uses the mobile terminal to view the obtained photograph according to the original size, the photograph needs to be first loaded into the memory according to the prior art. However, loading large photographs takes a lot of memory. It causes the mobile terminal to run slower after the mobile terminal loads the photograph. The response speed of the mobile terminal is also very slow when the photograph is dragged.

Therefore, the prior art needs to be improved and developed.

### SUMMARY OF THE DISCLOSURE

The technical problem to be solved by the present disclosure is to provide a method for loading a large size photograph and a system, which solve the existing problems that the memory space is occupied excessively and the operation response speed is slow when the mobile terminal views a photograph according to an original size.

To solve the above problems, the present disclosure provides the following technical solutions:

The present disclosure provides a method for loading a large size photograph, the method steps of: A, splitting a large size photograph into multiple sub-pictures having a preset size when a mobile terminal loads the large size photograph; B, moving a next sub-picture to a position of a current sub-picture according to a user slide direction on a touch screen of the mobile terminal and displaying in real-time.

In the method for loading a large size photograph, the step A comprises: A1, obtaining a size of the large size photograph to be loaded; A2, determining whether the size of the large size photograph is greater than a size threshold; and A3, splitting the large size photograph when the size of the large size photograph is greater than the size threshold.

In the method for loading a large size photograph, in the step A3, numbering the sub-pictures in a form of a two-dimensional matrix according to a position of each of the sub-pictures positioned in the large size photograph, respectively when splitting.

In the method for loading a large size photograph, the preset size is consistent with a size of the touch screen of the mobile terminal.

In the method for loading a large size photograph, the step B comprises: moving a sub-picture at a left side of and adjacent to the current sub-picture to the position of the current sub-picture when the user slide direction of the touch screen is a right direction and displaying in real-time; moving a sub-picture at a right side of and adjacent to the current sub-picture to the position of the current sub-picture when the user slide direction of the touch screen is a left direction and displaying in real-time; moving a sub-picture at a lower side of and adjacent to the current sub-picture to the position of the current sub-picture when the user slide direction of the touch screen is an up direction and displaying in real-time; moving a sub-picture at an upper side of and adjacent to the current sub-picture to the position of the current sub-picture when the user slide direction of the touch screen is a down direction and displaying in real-time.

The present disclosure provides a system for loading a large size photograph, which comprises: one or more processors; a memory; one or more applications, wherein the one or more applications are stored in the memory and configured to be executed by the processors; a photograph splitting module configured to split a large size photograph into multiple sub-pictures having a preset size when a mobile terminal loads the large size photograph; a display processing module configured to move a next sub-picture to a position of a current sub-picture according to a user slide direction on a touch screen of the mobile terminal and displaying in real-time.

In the system for loading a large size photograph, the photograph splitting module comprises: an obtaining unit configured to obtain a size of the large size photograph to be loaded; a determining unit configured to determine whether the size of the large size photograph is greater than a size threshold; and a splitting unit configured to split the large size photograph when the size of the large size photograph is greater than the size threshold.

In the system for loading a large size photograph, in the splitting unit, the sub-pictures are numbered in a form of a two-dimensional matrix according to a position of the sub-pictures positioned in the large size photograph, respectively when splitting.

In the system for loading a large size photograph, the preset size is consistent with a size of the touch screen of the mobile terminal.

In the system for loading a large size photograph, the display processing module comprises: a right shift display unit configured to move a sub-picture at a left side of and adjacent to the current sub-picture to the position of the current sub-picture when the user slide direction of the touch screen is a right direction and displaying in real-time; a left shift display unit configured to move a sub-picture at a right side of and adjacent to the current sub-picture to the position of the current sub-picture when the user slide direction of the touch screen is a left direction and displaying in real-time; an upper shift display unit configured to move a sub-picture at a lower side of and adjacent to the current sub-picture to the position of the current sub-picture when the user slide direction of the touch screen is an up direction and displaying in real-time; a lower shift display unit configured to move a sub-picture at an upper side of and adjacent to the current sub-picture to the position of the current sub-picture when the user slide direction of the touch screen is a down direction and displaying in real-time.

The present disclosure further provides a system for loading a large size photograph, which comprises: one or more processors; a memory; and one or more applications, wherein the one or more applications are stored in the memory and configured to be executed steps by the processors: A, splitting a large size photograph into multiple sub-pictures having a preset size when a mobile terminal loads the large size photograph; B, moving a next sub-picture to a position of a current sub-picture according to a user slide direction on a touch screen of the mobile terminal and displaying in real-time.

In the system for loading a large size photograph, the step A comprises: A1, obtaining a size of the large size photograph to be loaded; A2, determining whether the size of the large size photograph is greater than a size threshold; A3, splitting the large size photograph when the size of the large size photograph is greater than the size threshold.

In the system for loading a large size photograph, in the step A3, numbering the sub-pictures in a form of a two-dimensional matrix according to a position of the sub-pictures positioned in the large size photograph, respectively when splitting.

In the system for loading a large size photograph, the preset size is consistent with a size of the touch screen of the mobile terminal.

In the system for loading a large size photograph, the step B comprises: moving a sub-picture at a left side of and adjacent to the current sub-picture to the position of the current sub-picture when the user slide direction of the touch screen is a right direction and displaying the sub-picture in real-time; moving a sub-picture at a right side of and adjacent to the current sub-picture to the position of the current sub-picture when the user slide direction of the touch screen is a left direction and displaying the sub-picture in real-time; moving a sub-picture at a lower side of and adjacent to the current sub-picture to the position of the current sub-picture when the user slide direction of the touch screen is an up direction and displaying the sub-picture in real-time; and moving a sub-picture at an upper side of and adjacent to the current sub-picture to the position of the current sub-picture when the user slide direction of the touch screen is a down direction and displaying the sub-picture in real-time.

The beneficial effect is that the present disclosure divides large size photograph into a plurality of sub-pictures according to a preset size, and displays the corresponding sub-pictures according to the operation of the user dragging on the touch screen. The user only needs to load a sub-picture obtained by the segmentation when the user views the sub-picture according to a shooting size. Therefore, the size of the loaded sub-picture is smaller than the actual shooting size, which greatly reduces the memory space occupied by the user when viewing the large size photograph. The system can be ensured to run stably when viewing large size photograph and timely respond to user.

### BRIEF DESCRIPTION OF THE DRAWINGS

FIG. 1 a flowchart of a method for loading a large size photograph according to a preferred embodiment of the present disclosure.

FIG. 2 is a specific flowchart of a step S1 of the method shown in FIG. 1.

FIG. 3 is a schematic diagram of the division of a loading a large size photograph in the present disclosure.

FIG. 4 is a schematic view showing the movement of a loading a large size photograph in the present disclosure.

FIG. 5 is a structural block diagram of a system for loading a large size photograph according to an embodiment of the present disclosure.

FIG. 6 is a structural block diagram of a photograph splitting module shown in FIG. 5.

FIG. 7 is a schematic diagram of a system for loading a large size photograph according to an embodiment of the present disclosure.

### DETAILED DESCRIPTION OF THE PREFERRED EMBODIMENTS

The present disclosure provides a method for loading a large size photograph and a system, for the purposes of the present invention, technical solutions and advantages clearer, explicit, the following detailed description of the present invention further. It should be understood that the specific embodiments described herein are only intended to illustrate the present invention and are not intended to limit the present invention.

Referring to FIG. 1, a flowchart of a method for loading a large size photograph according to a preferred embodiment of the present disclosure is illustrated. The method comprises: S1, splitting a large size photograph into multiple sub-pictures having a preset size when a mobile terminal loads the large size photograph; and S2, moving a next sub-picture to a position of a current sub-picture according to a user slide direction on a touch screen of the mobile terminal and displaying in real-time.

In the embodiment, the large size photograph displayed by shooting size is divided into multiple sub-pictures, the sub-pictures need to load for each operation according to an operation of the user, so that a loading process only takes up the memory corresponding to the corresponding sub-pictures.

Compared with loading the large size photograph, the memory usage is significantly reduced. It can easily load, display and view the large size photograph without affecting the running speed of the mobile terminal.

The mobile terminal of the present disclosure is a portable electronic device such as a mobile phone or a tablet computer that can display photos.

The large size photograph generally refers to a photo with a large shooting size or a high resolution, which requires a large memory space during loading and display. Further, the large size photograph is defined, which is a photo that exceeds the default size threshold (such as 1000×1000 pixels) in the system. It is also possible that the mobile terminal adjusts the size threshold in real time according to the size of the currently available memory space by detecting the size of the currently available memory space. When the current available memory space is less than a first memory threshold (such as ⅓ of the total memory space), the size threshold is updated to be 500×500 pixels. Then, it is determined to be a large size photograph when a large size photograph is larger than 500×500 pixels, otherwise it is not determined to be a large size photograph. When the current available memory space is greater than a second memory threshold (such as ⅔ of the total memory space), the size threshold is updated to be 1500×1500 pixels. Then, it is determined to be a large size photograph when the large size photograph is larger than 1500×1500 pixels, otherwise it is not determined to be a large size photograph. When the size of the currently available memory space is between the first memory threshold and the second memory threshold, the determination is still performed according to the system default size threshold. For example, it is determined by the size threshold of 1000×1000 pixels. It is determined to be a large size photograph when the large size photograph is larger than 1000×1000 pixels, otherwise it is not determined to be a large size photograph. Concisely, the size of the large size photograph can be determined according to a certain fixed size threshold. It can also be determined in real time according to the current available memory condition of the mobile terminal (the size threshold is continuously updated). In this way, the user can conveniently set the large size photograph according to the current memory condition of the mobile terminal, and ensure the operation speed of the mobile terminal is not affected, and the user can smoothly load and display the large size photograph.

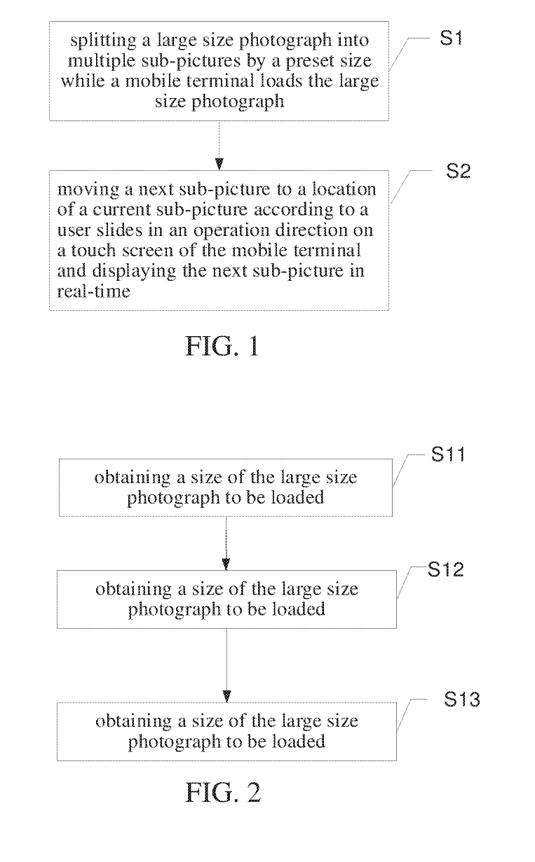

Further, as shown in FIG. 2, the step S1 specifically includes: S11, obtaining a size of the large size photograph to be loaded; S12, determining whether the size of the large size photograph is greater than a size threshold; and S13, splitting the large size photograph when the size of the large size photograph is greater than the size threshold.

After the mobile terminal detects the instructions of the user loads a photograph, the size of the large size photograph to be loaded is obtained, and the size threshold of photograph is determined according to the current state of the mobile terminal. It is determined to meet the required large size photograph when the size of the photograph to be loaded is larger than the size threshold. The large size photograph is split into several sub-pictures of a preset size. It is determined that the size of the large size photograph is small when the size of the photograph to be loaded is not larger than the size threshold. Loading the entire photograph will not have a big impact on the running memory of the mobile terminal, so the photograph will not be split and directly be loaded into the memory.

The size of the sub-pictures obtained by dividing the large size photograph can be preset by the user according to personal habits and preferences (such as 50×50 pixels). Preferably, the size of the sub-pictures is set to be the same as the size of the touch screen of the mobile terminal, and the setting can be that the user inputs the touch screen size of the mobile terminal. Preferably, the mobile terminal detects its own touch screen size, and the large size photograph is divided into several sub-pictures of the same size as the touch screen of the mobile terminal. The present disclosure will be described as an example.

Further, the step S13 further includes that the sub-pictures are numbered in a form of a two-dimensional matrix according to a position of the sub-pictures positioned in the large size photograph, respectively when splitting.

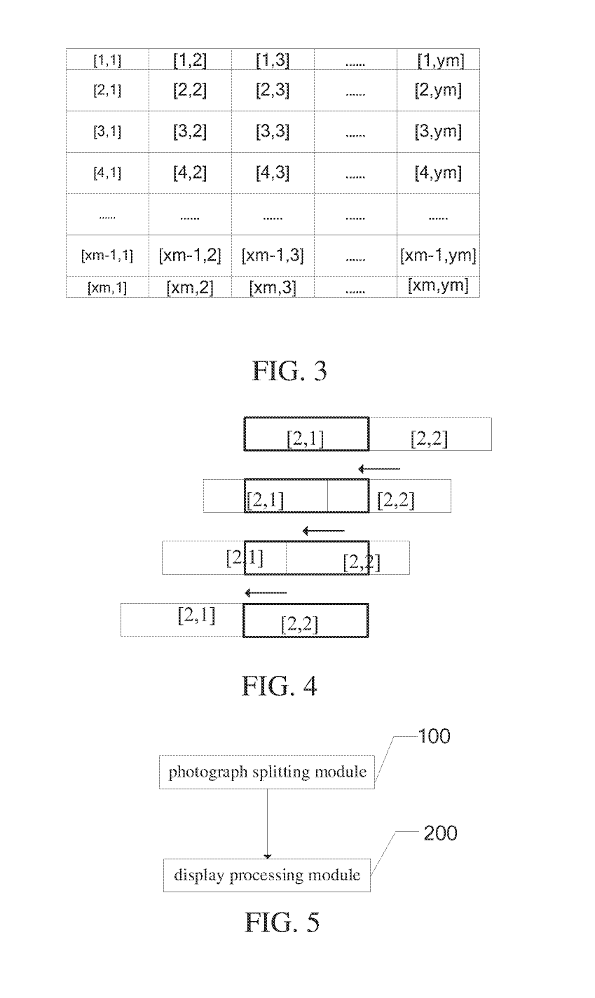

In order to facilitate subsequent movement and viewing of the sub-pictures, the sub-pictures are numbered by a two-dimensional matrix after dividing the large size photograph according to the preset size. The number includes two members, named horizontal members and vertical members, wherein the horizontal members are used to specify the row of the sub-pictures, and the vertical members are used to specify the column of the sub-pictures. As shown in FIG. 3, the large size photograph is divided into xm×ym sub-photos. Then, the number is processed by a two-dimensional matrix according to the position of each of sub-pictures in the large size photograph. For example, a sub-picture is positioned in the i-th row and the j-th column in the large size photograph, and the sub-picture is numbered [i, j].

As a preferred embodiment of the present disclosure, after the step S13, the method further includes that the sub-picture displayed in the center of a large size photograph is loaded after splitting. The main subject is usually positioned at the center of the photograph when taking a photo. From the center of a large size photograph, the user can easily view the sub-pictures in different positions by dragging the touch screen. Therefore, it is appropriate to select the sub-picture positioned at the center position as the initial display object of the large size photograph. In addition, the user can set the initial display object to a sub-picture of a certain position according to personal photo habits. For example, a sub-picture is positioned at the upper and left corner or a sub-picture is positioned at the upper and right corner.

Further, the large size photograph is split based on the center position of the large size photograph, expand to the upper and lower sides of the large size photograph according to the width of the preset size, and expand to the left and right sides of the large size photograph according to the length of the preset size to complete the sub-pictures of large size photograph. Then the sub-pictures are numbered in a two-dimensional matrix.

In step S2, the current the sub-picture gradually disappears from the touch screen of the mobile terminal when the user drags the touch screen of the mobile terminal in a certain direction, and the next sub-picture is gradually displayed on the touch screen of the mobile terminal. The user can drag in different directions on the touch screen of the mobile terminal, so that adjacent sub-pictures are displayed on the touch screen of the mobile terminal instead of the current sub-picture. In the process, the mobile terminal determines whether the acceleration of the user dragging the touch screen exceeds a preset acceleration threshold, or determines whether the displacement of the user dragging the touch screen exceeds a preset displacement threshold. If any of the above two conditions is satisfied, the current sub-picture displayed on the touch screen is replaced with the next sub-picture, or the current sub-picture is still displayed on the touch screen. In addition, the mobile terminal determines whether the acceleration of the user dragging the touch screen exceeds a preset acceleration threshold, and determines whether the displacement of the user dragging the touch screen exceeds a preset displacement threshold when the mobile terminal detects that the user drags the touch screen. When both of the above conditions are satisfied, the current sub-picture displayed on the touch screen is replaced with the next current. When any of the conditions is not satisfied, the current sub-picture is still displayed on the touch screen. In this way, the mobile terminal can effectively distinguish the reason that the user drags the screen by switching the current sub-picture or mis-operation, and effectively avoid loading photograph in the process of misuse, wasting the memory, reducing the speed of the mobile terminal.

As a preferred embodiment of the present disclosure, the step S2 further includes: a sub-picture is moved at a left side of and adjacent to the current sub-picture to the position of the current sub-picture when the user slide direction of the touch screen is a right direction and displaying the sub-picture in real-time; a sub-picture is moved at a right side of and adjacent to the current sub-picture to the position of the current sub-picture when the user slide direction of the touch screen is a left direction and displaying the sub-picture in real-time; a sub-picture is moved at a lower side of and adjacent to the current sub-picture to the position of the current sub-picture when the user slide direction of the touch screen is an up direction and displaying the sub-picture in real-time; and a sub-picture is moved at an upper side of and adjacent to the current sub-picture to the position of the current sub-picture when the user slide direction of the touch screen is a down direction and displaying the sub-picture in real-time.

In this embodiment, the user drags the touch screen to the left as an example shown in FIG. 4 (the bold frames are the current content displayed on the touch screen, and the non-bold frames are the divided sub-pictures). The current content displayed on the touch screen is a sub-picture numbered [2, 1] (row 2, column 1). If the user drags the touch screen to the left, the sub-picture numbered [2, 2] (row 2, column 2) on the right side of the current sub-picture is gradually moved to the left. The sub-picture numbered [2, 1] also moves to the left at the same time (the moving speed is the same as the sub-picture numbered [2, 2]). After moving a distance, the sub-picture numbered [2, 1] is finally replaced with the sub-picture numbered [2, 2] and displayed. It should be noted that these two sub-pictures are moved and displayed in real time. In other words, in the middle state, these two sub-pictures can be displayed at the same time. When moved in place, the previous sub-picture disappears and the next sub-picture is displayed.

Based on the above method, the present disclosure also provides a system for loading a large size photograph shown in FIG. 5, the system includes a photograph splitting module 100 configured to split a large size photograph into multiple sub-pictures having a preset size when a mobile terminal loads the large size photograph, and a display processing module 200 configured to move a next sub-picture to a position of a current sub-picture according to a user slide direction on a touch screen of the mobile terminal and displaying the next sub-picture in real-time.

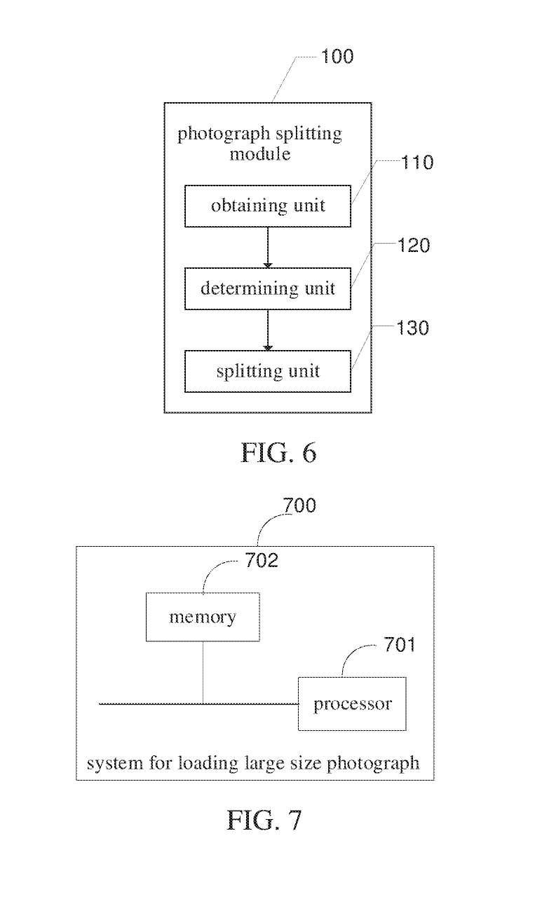

Referring to FIG. 6, the photograph splitting module 100 comprises an obtaining unit 110 configured to obtain a size of the large size photograph to be loaded, a determining unit 120 configured to determine whether the size of the large size photograph is greater than a size threshold; and a splitting unit 130 configured to split the large size photograph when the size of the large size photograph is greater than the size threshold.

Further, in the splitting unit 130, the sub-pictures are numbered in a form of a two-dimensional matrix according to a position of the sub-pictures positioned in the large size photograph, respectively when splitting the large size photograph. Further, the preset size is consistent with a size of the touch screen of the mobile terminal.

The display processing module 200 comprises a right shift display unit configured to move a sub-picture at a left side of and adjacent to the current sub-picture to the position of the current sub-picture when the user slide direction of the touch screen is a right direction and displaying the sub-picture in real-time; a left shift display unit configured to move a sub-picture at a right side of and adjacent to the current sub-picture to the position of the current sub-picture when the user slide direction of the touch screen is a left direction and displaying the sub-picture in real-time; an upper shift display unit configured to move a sub-picture at a lower side of and adjacent to the current sub-picture to the position of the current sub-picture when the user slide direction of the touch screen is an up direction and displaying the sub-picture in real-time; and a lower shift display unit configured to move a sub-picture at an upper side of and adjacent to the current sub-picture to the position of the current sub-picture when the user slide direction of the touch screen is a down direction and displaying the sub-picture in real-time.

The technical details of the above modules and units have been described in detail in the foregoing method, and therefore will not be described again.

As described above, the present disclosure divides large size photograph into a plurality of sub-pictures according to a preset size, and displays the corresponding sub-pictures according to the operation of the user dragging on the touch screen. The user only needs to load a sub-picture obtained by the segmentation when the user views the sub-picture according to a shooting size. Therefore, the size of the loaded sub-picture is smaller than the actual shooting size, which greatly reduces the memory space occupied by the user when viewing the large size photograph. The system can be ensured to run stably when viewing large size photograph and timely respond to user.

It should be noted, those of ordinary skill in the art will appreciate that all or part of the various steps of the above-described embodiments may be performed by a program to instruct related hardware. The program can be stored in a computer readable storage medium. The storage medium includes a read only memory (ROM), a random access memory (RAM), a magnetic disk, or an optical disk. As shown in FIG. 7, in the embodiment of the present disclosure, the system 700 for loading a large size photograph includes a processor 701 and a memory 702, wherein the memory 702 is connected to the processor 701, and the program is stored in the memory 402 and configured to be executed by the processor 701.

It shall be appreciated that the application of the present disclosure is not limited to the aforesaid examples. Those of ordinary skill in the art may make modifications or alterations according to the above descriptions, and all of these modifications and alterations shall be covered within the scope of the appended claims of the present disclosure.

1. A method for loading a large size photograph on a mobile terminal comprising a touch screen, the method comprising steps of:
A, splitting a large size photograph into multiple sub-pictures having a preset size; and
B, moving a next sub-picture to a position of a current sub-picture on the touch screen according to a user slide direction on a touch screen of the mobile terminal and displaying the next sub-picture in real-time.

2. The method for loading the large size photograph according to claim 1, wherein the step A comprises:
A1, obtaining a size of the large size photograph;
A2, determining whether the size of the large size photograph is greater than a size threshold; and
A3, splitting the large size photograph when the size of the large size photograph is greater than the size threshold.

3. The method for loading the large size photograph according to claim 2, wherein in the step A3, numbering the sub-pictures in a form of a two-dimensional matrix according to a position of each of the sub-pictures positioned in the large size photograph, respectively when splitting the large size photograph.

4. The method for loading the large size photograph according to claim 3, wherein the preset size is consistent with a size of the touch screen of the mobile terminal.

5. The method for loading the large size photograph according to claim 1, wherein the step B comprises:
moving a sub-picture at a left side of and adjacent to the current sub-picture to the position of the current sub-picture on the touch screen when the user slide direction of the touch screen is a right direction and displaying the sub-picture in real-time;
moving a sub-picture at a right side of and adjacent to the current sub-picture to the position of the current sub-picture on the touch screen when the user slide direction of the touch screen is a left direction and displaying the sub-picture in real-time; and
moving a sub-picture at a lower side of and adjacent to the current sub-picture to the position of the current sub-picture on the touch screen when the user slide direction of the touch screen is an up direction and displaying the sub-picture in real-time;
moving a sub-picture at an upper side of and adjacent to the current sub-picture to the position of the current sub-picture on the touch screen when the user slide direction of the touch screen is a down direction and displaying the sub-picture in real-time.

6. A system for loading a large size photograph, comprising:
one or more processors;
a memory;
one or more applications, wherein the one or more applications are stored in the memory and configured to be executed by the processors;
a photograph splitting module configured to split a large size photograph into multiple sub-pictures having a preset size; and
a display processing module configured to move a next sub-picture to a position of a current sub-picture on the touch screen according to a user slide direction on a touch screen of the mobile terminal and displaying the next sub-picture in real-time.

7. The system for loading the large size photograph according to claim 6, wherein the photograph splitting module comprises:
an obtaining unit configured to obtain a size of the large size photograph;
a determining unit configured to determine whether the size of the large size photograph is greater than a size threshold; and
a splitting unit configured to split the large size photograph when the size of the large size photograph is greater than the size threshold.

8. The system for loading the large size photograph according to claim 7, wherein in the splitting unit, the sub-pictures are numbered in a form of a two-dimensional matrix according to a position of the sub-pictures positioned in the large size photograph, respectively when splitting the large size photograph.

9. The system for loading the large size photograph according to claim 8, wherein the preset size is consistent with a size of the touch screen of the mobile terminal.

10. The system for loading the large size photograph according to claim 6, wherein the display processing module comprises:
a right shift display unit configured to move a sub-picture at a left side of and adjacent to the current sub-picture to the position of the current sub-picture on the touch screen when the user slide direction of the touch screen is a right direction and displaying the sub-picture in real-time;
a left shift display unit configured to move a sub-picture at a right side of and adjacent to the current sub-picture to the position of the current sub-picture on the touch screen when the user slide direction of the touch screen is a left direction and displaying the sub-picture in real-time;
an upper shift display unit configured to move a sub-picture at a lower side of and adjacent to the current sub-picture to the position of the current sub-picture on the touch screen when the user slide direction of the touch screen is an up direction and displaying the sub-picture in real-time; and
a lower shift display unit configured to move a sub-picture at an upper side of and adjacent to the current sub-picture to the position of the current sub-picture on the touch screen when the user slide direction of the touch screen is a down direction and displaying the sub-picture in real-time.

11. A system for loading a large size photograph, comprising:
one or more processors;
a memory; and
one or more applications, wherein the one or more applications are stored in the memory and configured to be executed by the processors, and the one or more applications comprises:
A, splitting a large size photograph into multiple sub-pictures having a preset size; and
B, moving a next sub-picture to a position of a current sub-picture on the touch screen according to a user slide direction on a touch screen of the mobile terminal and displaying the next sub-picture in real-time.

12. The system for loading the large size photograph according to claim 11, wherein the step A comprises:
A1, obtaining a size of the large size photograph;
A2, determining whether the size of the large size photograph is greater than a size threshold; and
A3, splitting the large size photograph when the size of the large size photograph is greater than the size threshold.

13. The system for loading the large size photograph according to claim 12, wherein in the step A3, numbering the sub-pictures in a form of a two-dimensional matrix according to a position of the sub-pictures positioned in the large size photograph, respectively when splitting the large size photograph.

14. The system for loading the large size photograph according to claim 12, wherein the preset size is consistent with a size of the touch screen of the mobile terminal.

15. The system for loading the large size photograph according to claim 12, wherein the step B comprises:
moving a sub-picture at a left side of and adjacent to the current sub-picture to the position of the current sub-picture on the touch screen when the user slide direction of the touch screen is a right direction and displaying the sub-picture in real-time;
moving a sub-picture at a right side of and adjacent to the current sub-picture to the position of the current sub-picture on the touch screen when the user slide direction of the touch screen is a left direction and displaying the sub-picture in real-time;
moving a sub-picture at a lower side of and adjacent to the current sub-picture to the position of the current sub-picture on the touch screen when the user slide direction of the touch screen is an up direction and displaying the sub-picture in real-time; and
moving a sub-picture at an upper side of and adjacent to the current sub-picture to the position of the current sub-picture on the touch screen when the user slide direction of the touch screen is a down direction and displaying the sub-picture in real-time.
